(19) United States
(12) Patent Application Publication
(10) Pub. No.: US 2018/0029912 A1
(43) Pub. Date: Feb. 1, 2018

(54) PRIMARY FILTER AND STORAGE SYSTEM

(71) Applicant: TAT-YUNG NG, NORTH POINT (HK)

(72) Inventor: TAT-YUNG NG, NORTH POINT (HK)

(21) Appl. No.: 15/609,462

(22) Filed: May 31, 2017

(30) Foreign Application Priority Data
Jul. 26, 2016 (CN) 201620795707.0

(51) Int. Cl. C02F 9/00; B01D 39/16; B01D 39/06; C02F 1/00; B01D 36/02

(52) U.S. Cl. CPC C02F 9/00; C02F 1/008; B01D 36/02; B01D 39/06; B01D 39/1615; C02F 1/325

(57) ABSTRACT

Disclosed is a primary filter and storage system comprising a power source, a water pump, a filter device, an ultraviolet sterilization device, a water storage device and a control circuit, wherein an inlet of the filter device is connected with a water source, and an outlet of the filter device is connected with the ultraviolet sterilization device; an outlet of the ultraviolet sterilization device is connected with the water storage device. The primary filter and storage system can be used for primary optimization and storage of pure water obtained through air purification and condensation, and thus the pure water can be further optimized by the next-stage water purification system conveniently to reach the standard of the optimal drinking water.

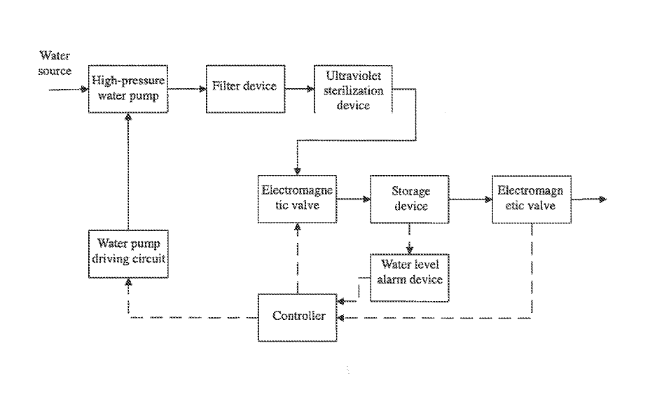

### BACKGROUND OF THE INVENTION

### Technical Field

The invention relates to water treatment equipment, in particular to a primary filter and storage system.

### Description of Related Art

Existing fresh water resources which can be easily utilized by humans are mainly from rivers, lakes and shallow groundwater; the fresh water resources are deficient due to large consumption, and clean water resources in places with abundant electricity and energy are also relatively deficient and need to be saved and protected due to serious pollution and extremely imbalanced regional distribution; water resources have already been precious resources for humans, and water resource problems even become a major strategy concerning sustainable development of the national economy and society, and lasting political stability.

In certain remote arid and distressed areas where clean water resources are extremely difficult to obtain and water resource shortages exist, it is hard to lay long delivery pipelines for long-distance supply of drinking water, or to transport drinking water back and forth through transportation facilities without considering transportation costs, or to mount large water quality optimization systems, and consequentially, the cost of safe drinking water becomes extremely high; besides the high drinking water cost, water quality changes or secondary pollution can be caused by long-distance delivery or transportation, and consequentially, water cannot be directly drunk by people safely.

Although the personal demand for drinking water of people in daily life is not large, the requirements for the sanitation, cleanliness, sterility and non-toxicity of the drinking water are high; drinkable pure water can be obtained through air purification and condensation, however, the pure water obtained simply through air purification and condensation still cannot reach the standard of high-quality drinking water and needs to be further optimized to reach the water quality standard of the high-quality drinking water.

### BRIEF SUMMARY OF THE INVENTION

For solving the technical problems, the invention provides a primary filter and storage system which can pre-treat water when pure water obtained through air purification and condensation is further optimized.

According to the technical scheme adopted by the invention for solving the technical problems, the primary filter and storage system comprises a power source, a water pump, a filter device, an ultraviolet sterilization device, a water storage device and a control circuit, wherein an inlet of the filter device is connected with a water source, and an outlet of the filter device is connected with the ultraviolet sterilization device; an outlet of the ultraviolet sterilization device is connected with the water storage device.

According to the primary filter and storage system, the filter device comprises a fiber mesh filter, a PP cotton filter, a quartz sand filter, a particle carbon filter and an active carbon filter.

According to the primary filter and storage system, the fiber mesh filter, the PP cotton filter, the quartz sand filter, the particle carbon filter and the active carbon filter are sequentially connected in series, the fiber mesh filter is connected with the water source through the water pump, and an outlet of the active carbon filter is connected with the ultraviolet sterilization device.

According to the primary filter and storage system, the control circuit comprises a controller, the water storage device comprises a plurality of water containers, each water container comprises a water level alarm device, a water inlet electromagnetic valve and a water outlet electromagnetic valve, and the signal output end of each water level alarm device, the control end of each water inlet electromagnetic valve and the control end of each water outlet electromagnetic valve are all connected with the controller; the control end of a water pump driving circuit is connected with the controller.

According to the primary filter and storage system, the power source is a solar power source.

The primary filter and storage system of the invention can be used for primary optimization and storage of pure water obtained through air purification and condensation, and thus the pure water can be further optimized by the next-stage water purification system conveniently to reach the standard of optimal drinking water.

### BRIEF DESCRIPTION OF THE SEVERAL VIEWS OF THE DRAWINGS

A further detailed description of the invention is given with the accompanying drawing and the specific execution mode as follows.

The FIGURE is a chart of a primary filter and storage system of an embodiment of the invention.

### DETAILED DESCRIPTION OF THE INVENTION

The FIG. shows the structure of a primary filter and storage system of an embodiment of the invention, and the primary filter and storage system comprises a power source, a high-pressure water pump, a filter device, an ultraviolet sterilization device, a water storage device and a control circuit, wherein an inlet of the filter device is connected with a water source, and an outlet of the filter device is connected with the ultraviolet sterilization device; an outlet of the ultraviolet sterilization device is connected with the water storage device.

Wherein, the filter device comprises a fiber mesh filter, a PP cotton filter, a quartz sand filter, a particle carbon filter and an active carbon filter. The fiber mesh filter, the PP cotton filter, the quartz sand filter, the particle carbon filter and the active carbon filter are sequentially connected in series, the fiber mesh filter is connected with the water source through the high-pressure water pump, and an outlet of the active carbon filter is connected with the ultraviolet sterilization device.

The control circuit comprises a controller, the water storage device comprises a plurality of water containers, each water container comprises a water level alarm device, a water inlet electromagnetic valve and a water outlet electromagnetic valve, and the signal output end of each water level alarm device, the control end of each water inlet electromagnetic valve and the control end of each water outlet electromagnetic valve are all connected with the controller; the control end of a high-pressure water pump driving circuit is connected with the controller.

In the embodiment, the power source is a solar power source.

The primary filter and storage system of the embodiment of the invention can collect the water source of a plurality of air purification and condensation water-production systems, for avoiding the influence on the water-production quantity and the increase of the size of a machine body, only simple filtration is conducted by the water-production systems, and the primary filter and storage system is responsible for major water source filtration and purification after water-production; all water source filtration, purification and sterilization work of the system is promoted through the high-pressure water pump, the operating condition and information of the system are monitored through the controller of the control circuit of the system in each procedure, and the operating information, the system working condition and alarm information are summarized and synchronously transmitted to a master control system of a central control room through the controller. In addition, the primary filter and storage system is characterized in that a solar power supply system is used for providing the required power source, so that the environment is protected, and energy is saved.

According to the embodiment of the invention, the water source is purified and odors in the water are absorbed when the water source passes through the filter device, the purified water passes through a stainless steel high-energy ultraviolet sterilization system before entering the water storage device, and the water source enters the water storage device after being further optimized.

According to the embodiment of the invention, the water storage device is composed of a plurality of water tanks, the water inlet and water outlet of each water tank is controlled by the control system through a water level alarm device and electromagnetic valves, the storage quantity and the using quantity are also monitored, and when the storage quantity is too large, the upstream water-production system can be informed through a monitoring system of the central control room to stop distributing water, so that water source waste is avoided, and equipment loss is reduced.

The primary filter and storage system of the embodiment of the invention can be used for primary optimization and storage of pure water obtained through air purification and condensation, and thus the pure water can be further optimized by the next-stage water purification system conveniently to reach the standard of the optimal drinking water. Meanwhile, the primary filter and storage system can reduce the load of the next-stage water purification system, the service life of an RO mold is prolonged, flushing and sewage discharge of the RO mold are reduced, and emission is reduced while energy is saved.

What is claimed is:

1. A primary filter and storage system, comprising a power source, a water pump, a filter device and a control circuit, characterized by further comprising an ultraviolet sterilization device and a water storage device, wherein an inlet of the filter device is connected with a water source, and an outlet of the filter device is connected with the ultraviolet sterilization device; an outlet of the ultraviolet sterilization device is connected with the water storage device.

2. The primary filter and storage system according to claim 1, characterized in that the filter device comprises a fiber mesh filter, a PP cotton filter, a quartz sand filter, a particle carbon filter and an active carbon filter.

3. The primary filter and storage system according to claim 2, characterized in that the fiber mesh filter, the PP cotton filter, the quartz sand filter, the particle carbon filter and the active carbon filter are sequentially connected in series, the fiber mesh filter is connected with the water source through the water pump, and an outlet of the active carbon filter is connected with the ultraviolet sterilization device.

4. The primary filter and storage system according to claim 1, characterized in that the control circuit comprises a controller, the water storage device comprises a plurality of water containers, each water container comprises a water level alarm device, a water inlet electromagnetic valve and a water outlet electromagnetic valve, and the signal output end of each water level alarm device, the control end of each water inlet electromagnetic valve and the control end of each water outlet electromagnetic valve are all connected with the controller; the control end of a water pump driving circuit is connected with the controller.

5. The primary filter and storage system according to claim 1, characterized in that the power source is a solar power source.
